(19) United States
(12) Patent Application Publication
(10) Pub. No.: US 2013/0203879 A1
(43) Pub. Date: Aug. 8, 2013

(54) Method For The Production Of Foam Moulded Parts

(71) Applicant: SYNBRA TECHNOLOGY B.V., Etten-Leur (NL)

(72) Inventors: Petrus Frederikus Maria Rensen, Doornenburg (NL); Jan Noordegraaf, Wijchen (NL); Kenneth Van Den Hoonaard, Wijchen (NL); Petrus Henricus Johannes Van Der Burgt, Horssen (NL)

(73) Assignee: SYNBRA TECHNOLOGY B.V., Etten-Leur (NL)

(21) Appl. No.: 13/759,688

(22) Filed: Feb. 5, 2013

(30) Foreign Application Priority Data
Feb. 6, 2012 (NL) 2008240

(51) Int. Cl. C08L 25/06; C08L 29/04

(52) U.S. Cl. CPC C08L 25/06; C08L 29/04
USPC 521/139; 264/109

(57) ABSTRACT

The present invention relates to a method for the manufacture of foam moulded parts. Further the present invention relates to foamed moulded parts. The present method comprises the following steps:
i) providing polymer foam granules,
ii) mixing the polymer foam granules with a glue composition,
iii) addition of a heat transfer medium to the mixture obtained in step
ii) in order to obtain a foamed moulded part.

### BACKGROUND OF THE INVENTION

1. Field of the Invention

The present invention relates to a method for the production of foam moulded parts. The invention also relates to foam moulded parts.

2. Description of the Related Art

A similar material is known from the European patent EP 1 486 530 in the name of the present inventor. The aforementioned European patent discloses a foam with a fine cell structure and a low density whereby an improvement in the heat insulation value thereof due to the presence of active carbon as a heat insulating material in the polystyrene particles.

According to US 2005/0266244 an expanded polystyrene granule with a functional layer is known. Accordingly a solution of polyvinyl acetate containing a functional additive, is applied as a coating. The method includes firstly expanding the expandable polystyrene granules and thereafter the thus expanded polystyrene granules are mixed by stirring with the said polyvinyl acetate solution, and wherein during the mixing hot air is added, followed by the addition of the so called release agent in order to obtain an amount of separate particles. The thus obtained amount of separate particles is dried and transported over a steam mould through which steam is dosed in order to fuse the separate particles together to obtain a foamed moulded part that exhibits a compact structure. As a result of the said expansion step it can be said that there is a functionalized coating within an expanded structure.

According to the Dutch patent NL 1033719 in the name of the present applicant a method for the production of foamed moulded parts is disclosed wherein particles of polylactic acid are impregnated in a pressure vessel with a blowing agent, namely CO₂ at a pressure of 20 bar for 5 hours. The accordingly obtained particles of polylactic acid are subsequently pre-foamed or pre-expanded by application of warm air (with a temperature of about 90° C.) for a duration of 1 minute. The pre-foamed particles of polylactic acid have a density of approximately 60 g/l. Finally the pre-foamed particles of polylactic acid are coated in a fluidized bed reactor and after the coating of the pre-foamed polylactic acid particles the particles are once again impregnated with a blowing agent namely CO₂ by treatment in a pressure vessel at 20 bar for a duration of 20 minutes. The once again impregnated particles of polylactic acid contain approximately 7% by mass of CO₂. Subsequently the once again impregnated particles of polylactic acid are added to an industrial production unit for foamed moulded parts, wherein by application of steam further expansion and fusion from the pre-foamed particles of polylactic acid occurs to obtain a foamed moulded part, with a density of 60 g/l. According to the Dutch patent NL 1033719 it is also possible to place particles of polylactic acid after extrusion in a fluidized bed reactor to provide a coating, namely by application of a solution of 50% weight by mass of polyvinyl acetate. After coating the thus coated particles of polylactic acid are impregnated with a blowing agent, namely CO₂, by treatment in a pressure vessel at a pressure of 20 bar for a duration of 20 minutes. The impregnated particles of polylactic acid contain approximately 7% weight by mass of CO₂ and a subsequently added to an industrial production unit for foamed moulded parts, wherein by application of steam expansion and fusion of the particles of polylactic acid takes place to obtain a foamed moulded part, with a density of 60 g/l, In both methods the impregnation of the blowing agent is an essential step.

Particle based expandable polystyrene (EPS) is not only used as a packaging material but also in construction elements, for example as panels in the housing industries. Specific properties are required for such panels with regard to amongst others heat insulation, sound insulation and fire resistance (fire retardance). The present invention is focussed above all on the development of a particle based, expandable polystyrene (EPS) wherein the fire retardance of the materials, wherein EPS is present, is optimalized, wherein it is meant that such applications must meet the strict fire retardants requirements, in particular the DIN 4101-B2 test.

In the aboriculture and in the greenhouse cultivation industry is lots of substrate (for example soil) used as a medium for the growth of plants. This above all means the growing of plants under glass and the growing of nursery-trees in containers. The used substrates consist mostly of rough particles of pulverized peat, that is used in order to make the earth airy. Another growth substrate that is used in the cultivation sector is stone wool. Actually this is a very costly growth substrate. A disadvantage is above all that this material is difficult to break down. Important characteristics for growth substrates are, above all, the biodegradation, mechanical strength and porosity (for the conductance of water and air).

Further insulation panels that are made from foam are used as covers for interior divisions or walls. In such a situation when insulation panels are for example attached to an interior division, damp or moisture can build up between the panel and the wall. In order to prevent undesired development of damp the insulation panels are often provided with channels in order to facilitate the transport of the damp.

The production of foam moulded parts can according to international patent application WO2011133035 in the name of the present applicant occur according to a method whereby the starting materials, which can possibly be pre-expanded in so called steam chambers, whereby a further expansion of the polystyrene particles occurs. During this possible pre-foaming virgin EPS is for example treated under influence of steam, whereby the granules of expanded polystyrene are expanded. After such treatment the thus pre-foamed EPS can be further developed in a subsequent treatment, that is maturing, in particular storing the thus treated granules for a period of 4 to 48 hours. The final form occurs by treating the different starting materials in a steam mould or a steam treated mould. During the said process the particles will adhere to each other and a compact structure is formed. Before the said steam chambers or moulds are filled with a combination of starting materials, firstly a mixture of the desired EPS material is produced, whereby the desired composition is summarized in the dependent claims. After putting together the desired mixture, whereby the starting materials in particular are taken from silo's. The containers in the form are filled and thereafter steam is bubbled through. Due to the high temperature of the steam the present blowing agent will attempt to expand, and the EPS particles will fuse together due to the steam heating them to above the glass transition temperature en also due to the limited room in the form. The mould used here fore is provided with small openings through which the blowing agent and steam can pass.

The object of the present invention is to provide a method for the production of foam moulded parts, which foam moulded parts have a high temperature resistance.

Another object of the present invention is the production of a foam moulded part that is suitable for use as a growth substrate in the agricultural and horticulture industries, in particular in the greenhouse industry.

A further object is the provision of a method to manufacture a foamed moulded part, in which the porosity of the foamed moulded part is tuneable.

A further object of the present invention is the provision of a foam moulded part which is suitable for use in insulation applications, in particular as an insulation panel for interior wall insulation applications.

### SUMMARY OF THE INVENTION

The present application as herein described in the introduction is characterized in that the method includes the following steps:
i) the provision of polymer foam granules
ii) the mixing of polymer foam granules with a glue composition,
iii) flowing a heat transporting medium through the mixture obtained in step ii) to obtain a foam moulded part.

By applying such a method one or more of the aims of the present invention are met. In the previously stated steps of the present method it is obvious that there is no impregnation with a blowing agent, in contrast to the methods disclosed in the herein previously discussed Dutch patent NL 1033719, wherein it is stated that after a step of coating an impregnation is necessary with a blowing agent. in particular CO₂.

### DESCRIPTION OF THE INVENTION

The present method shows that between carrying out steps i) and ii), or between step ii) and iii), further more during step ii) and/or iii) there is no impregnation of a blowing agent. Above all it must be stated that in step i) a polymer foam granule is used as a starting material wherein no blowing agent is present, that is the percentage of blowing agent is lower than 0,1 weight %, in particular lower than 0,01 weight %, especially lower than 0,001 weight % relative to the mass of the polymer foam granule. The starting material used in step i) is in particular a already foamed polymer granule, and there is in the present invention no impregnation step using a single blowing agent. In a particular embodiment of the present invention it is possible to use a combination of foamed polymer granules, whereby recycled materials may also be used. The treatment conducted in step iii) involves therefore the compression or pressing together the mixture of polymer foam granules and glue composition in order to produce adhesion between the components. There is thus no mention of an expansion step, as is described in the prior art.

By applying the said method it is therefore apparent that a foam moulded part can be made which has an open structure, whereby the open structure should be seen as “spaces” between polymer granules adhering to each other. Such an open structure makes the foam moulded parts particularly suitable as a growth substrate for the growing of for example plants and vegetables whereby the roots thereof can adhere to the substrate. Such an open structure is also desirable in applications such as insulation panels for interior wall insulation whereby the naturally present channels between the polymer granules adhered to one another provide a means of transporting the damp through the panel, as well as providing the intended heat insulation characteristics. Furthermore the substrate made using the present method is also suitable to be used in drainage applications in particular due to the open structure.

In preferred embodiment is it above all desirable that in step iii) hot air is used as the heat transfer medium. Application of hot air ensures that the polymer granules and the glue composition develop a good adhesion, via which a compact moulded part is made. Above all the hot air ensures removal of the solvent used in the glue composition used in step ii).

In a particular embodiment it is desirable that the polymer foam granules are chosen from the group consisting of E-PLA (expanded polylactic acid), PLA-starch mix (polylactic acid-starch mix), PLA-PBAT mix (polylactic acid-poly(butylene adipate-co-terephthalate) mix), PLA with PHA (polylactic acid with polyhydroxyalkanoate compounds), EPS, EPS/PPO, EPP, EPE, E-PET (expanded polyethylene terephthalate) and starch foam, or combinations thereof. Particular examples include E-PLA foam with a high degree of crystallization or amorphous, preferably between 10 and 50% as measured by DSC, E-PLA foam amorphous, with a degree of crystallization of approximately 0%, as measured by DSC, E-PLA mixture comprising 40% P-DLA and 60% PLLA, PLA-starch mix (Thermoplastoic Starch), with an amount of PLA in the region of 10-50%, PLA-PBAT (ecoflex) mix, PLA with PHA. The abbreviation PLA stands for polylactic acid, PHA for polyhydroxyalkanoate compounds, EPS for expanded polystyrene, PPO for poly(p-phenyleneoxide), EPP for expanded polypropylene, EPE for expanded polyethene, PET for polyethylene terephthalate.

In an embodiment of the present invention the glue composition is based on one or more components chosen from the group of polyvinyl alcohol, polyvinyl acetate and styrene. Also belonging to glue compositions are latex. Another glue composition that can be named is PU and PA latexes. The amount of glue composition in the mixture of glue composition and polymer granules is in the range of about 5-50% by weight, preferably 10-40% by weight, more preferably about 10-30% by weight, calculated on basis of the amount of glue, as solids, on the amount of polymer granules. For example if one starts with 12 liter polymer granules of the Bio Foam type, the weight thereof is about 200 g (density 17 g/l). The glue composition to be added is 7,5 g/l glue having a solids content of about 45%, resulting in about 36 g glue. The weight percentage glue is 18% of 200 g polymer granules, consequently.

The present method is further characterized in that step ii) further comprises after mixing the obtained mixture of glue composition and polymer foam granules placing the mixture between two pressure bodies and subsequently providing pressure or compression created by the two pressure bodies wherein there is no expansion.

Carrying out an additional pressure step ensures a good mutual adhesion between the with glue composition wetted polymer foam granules. Mixing of the glue composition and the polymer foam granules can for example occur in a mixer where the polymer foam granules thus coated with a glue composition can be placed in for example a mould, which mould is provided with a number of openings in order to make the passage of a heat transfer medium possible. Such a method is can also be seen as a batch process.

In a particular embodiment the two pressure bodies comprise two parallel oriented transport or conveyor belts in between which the mixture of glue composition and polymer foam granules is located. These belts are located one above the other so that the mixture of glue composition and polymer foam granules is poured on the lower band and compression is exerted by the position of the two transport belts. Thus it is possible to carry out the present invention in a continuous process. In an embodiment of the present invention an amount of a glue composition is mixed in a mixing apparatus with the polymer foam granules, whereby the thus obtained mixture is added to the transport belt. By using a spacer it is possible to alter the height between the two transport bands whereby in fact a defined compression can be provided to the mixture. It is thus possible to obtain a moulded part that has for example a density of 30 kg per cubic meter, starting from a polymer granule with a density of for example 20 kg per cubic meter. The compression is preferably in the range of 10-50%, preferably in the range of 15-40%, more preferably 20-30%. By choosing the glue composition it is possible to provide the final moulded parts with specific properties, for example to increase the density, the flame retardance, the increase in damp transport properties, antibacterial, antistatic, colour and smell. It is also possible to manufacture foam moulded parts with any desired length. The transport belts are carried out in such a way that for example perforations can be present, that enable the addition of a heat transfer medium to the mixture of glue composition and polymer foam granules. It is also possible to contact the thus treated polymer foam granules with a further treatment with steam.

The present glue composition can further comprise additives chosen from the group consisting of perfume agents, colouring agents, damp transport influencing agents, materials to increase the heat insulation value and flame retardance, antistatic agents. Examples of these are for example expandable graphite, phosphates, phosphate esters, aluminium hydroxide, magnesium hydroxide, sodium metasilicate (water glass), potassium metasilicate, metal hydroxides or metal oxides, metal pigments, silicates and glass fibres. A suitable binding or adhesive agent can be, for example Vinnapas 733HD, Cordifix SP 1003 and Vinnex 2510.

As suitable additives the following can be named: expandable graphite, trass, Ettringite, namely calcium aluminium sulphate mineral Ca₆Al₂O₃(SO₄)₃(OH)₁₂26H₂O, (CaO)₆(Al₂O₃)(SO₃)₃32H₂O, (CaO)₃(Al₂O₃)(CaSO₄)₃32H₂O, hexacalciumaluminatrisulphatehydrate, calcium silicate (Ca₂SiO₄), polyvinylpyrrollidone (PVP), expandable perlite, wollastonite (CaCO₃) and other clays.

The invention shall be further explained by the following non limiting examples.

### Example 1

An amount of foam based on EPS (Biofoam, manufactured by Synbra, Etten Leur, NL), was mixed with a glue composition based on polyvinyl alcohol (Cordifix SP 1003, manufactured by Cordial, Groningen, NL). After mixing these said polymer foam granules with the glue the mixture was added to a static mould and treated with hot air. The obtained moulded part met the requirements for the Euroclass E fire test.

### Example 2

Example 1 was repeated but the glue composition used was polyvinyl acetate Vinnex 2510 (manufactured by Wacker, Burghausen, DE).

### Example 3

Example 2 was repeated but the glue composition used was Vinnex 2510 (manufactured by Wacker, Burghausen, DE), wherein expandable graphite was added.

### Example 4

Example 1 was repeated but instead of a static mould a movable mould was used, in particular a construction comprising two parallel oriented transport belts in between which the mixture of glue composition and foam granule was added and air was also added.

The results from the said examples are found in Table 1. All thus obtained moulded parts met the requirements of Euroclass E fire test.

Additional experiments on basis of the continuous process as disclosed in Example 4 were conducted and the results are shown in Table II. The term “DS” means compressive strength (EN 826). The term “TS” means tensile strength (EN 1607). The term “BS” means strength at break (EN 12089).

The invention must be seen as a method for the manufacture of a foam moulded part with an open structure, which open structure is obtained by adhesion of already foamed polymer granules to each other by application of a adhesion agent and treating the thus adhered polymer granules with a heat transfer medium. The said open structure makes it possible to use the foam moulded part as a growth substrate for vegetables and plants but also as an insulation panel in interior wall insulation applications.

TABLE I

| Measurements large mold | | | | | |
|---|---|---|---|---|---|
| | | | | Com- | Final |
| | | | Thick- | pression | thick- |
| | Length | Breadth | ness | Mm | ness |
| Static | 1055 | 625 | 110 | 20 | 87 |
| mould | | | | | |
| Movable | | 1200 | 100 | 30 | 77 |
| mould | | | | | |

Static mould

| | | | | | | | | Drying | | Com- | | | |
|---|---|---|---|---|---|---|---|---|---|---|---|---|---|
| | | | | Addition | | | Drying | temper- | Final | pression | lambda | | |
| | | Glue | | Glue | | | time | ature | density | strength | value | Fire test | |
| Material | kg/m³ | Supplier | Type | kg/m3 | Mixture | kg/m³ | minutes | ° C. | kg/m³ | kPa | mW/Mk | method | result |
| BioFoam | 16.5 | Cordial, | Cordifix | 5 | | | 15 | 36 | 20.8 | 47.2 | 38 | Euro- | pass |
| | | Groningen | SP | | | | | | | | | class E | |
| | | | 1003 | | | | | | | | | | |
| BioFoam | 17 | Wacker, | Vinnex | 5 | | | 15 | 36 | 22 | 55 | 38 | Euro- | pass |
| | | Burghausen | 2510 | | | | | | | | | class E | |
| EPS | 17 | Wacker, | | 2 | expandable | 5 | 25 | 36 | 22 | 55 | 38 | Euro- | pass |
| 710F | | Burghausen | | | graphite | | | | | | | class E | |
| Movable mould | | | | | | | | | | | | | |
| | | | | | | Drying | | Com- | | | | | |
| | | | | | Drying | temper- | Final | pression | lambda | | | | |
| | | Glue | | | time | ature | density | strength | value | Fire test | | | |
| Material | kg/m³ | Supplier | Type | Addition | minutes | ° C. | kg/m³ | kPa | mW/Mk | method | result | | |
| BioFoam | 16.5 | Cordial, | Cordifix | 5 | 4 | 45 | 29 | 55 | 39 | Euro- | pass | | |
| | | Groningen | SP | | | | | | | class E | | | |
| | | | 1003 | | | | | | | | | | |

TABLE II

| | | Amount | | Drying | | | | | | BS after | BS after | |
|---|---|---|---|---|---|---|---|---|---|---|---|---|
| | | glue | Com- | temper- | | | | | | com- | compression | |
| Starling | | (g/L | pression | ature | Density | | | | BS initial | pression | dried at | B2 |
| material | Glue | nat) | (%) | (° C.) | (kg/m³) | λ (W/mK) | DS (kPa) | TS (kPa) | (kPa) | nat (kPa) | 40 ° C. (kPa) | results |
| BioFoam | Cordial with | 20 | 15 | 65 | 29.64 | 0.03942 | 60.8 | 85.4 | 88.6 | 18.45 | 93.35 | |
| | graphite | | | | | | | | | | | |
| BioFoam | Cordial with | 20 | 20/25 | 65 | 30.08 | 0.03908 | 66.5 | 110.0 | 102.6 | 22.8 | 102.55 | |
| | graphite | | | | | | | | | | | |
| BioFoam | Coridal with | 20 | 20/30 | 65 | 34.98 | 0.03864 | 86.6 | 149.6 | 147.3 | 35.3 | 138.85 | |
| | graphite | | | | | | | | | | | |
| BioFoam | Cordial with | 30 | 30 | 65 | 35.77 | 0.03885 | 86.3 | 164.0 | 147.8 | 37.1 | 138 | |
| | graphite | | | | | | | | | | | |
| BioFoam | Blue (drainage | 35 | 30 | 65 | 31.76 | 0.03761 | 88.5 | 136.6 | 139.8 | 19.7 | | |
| | plate) | | | | | | | | | | | |
| BioFoam | Blue (drainage | 35 | 30 | 50 | 31.55 | 0.03778 | 84 1 | 138.6 | 139.4 | 17.05 | 132.4 | |
| | plate) | | | | | | | | | | | |
| BioFoam | Blue (drainage | 12 | 30 | 50 | 27.38 | 0.03733 | 74.4 | 70.6 | 97.9 | 0 | | pass |
| | plate) | | | | | | | | | | | |
| BioFoam | Vinnex | 12 | 30 | 50 | 33.77 | 0.03789 | 73.4 | 100.4 | 168.4 | 37.9 | 161.05 | pass |
| BioFoam | Vinnex | 12 | 30 | 50 | 34.95 | 0.03782 | 78.4 | 161.1 | 172.3 | 40.3 | 161.3 | pass |
| BioFoam | Vinnex | 20-8 | 30 | 50 | 40.27 | 0.03805 | 77.3 | 159.2 | 184.5 | 37.9 | 173.35 | pass |
| BioFoam | Vinnex | 20-8 | 30 | 50 | 39.12 | 0.03803 | 75.2 | 147.5 | 163.4 | 38.8 | 137.05 | pass |
| EPS white | Cordial with | nd | nd | nd | 31.23 | 0.03727 | 67.4 | 96.1 | 108.1 | 0 | 83.6 | pass |
| | graphite | | | | | | | | | | | |
| Neopor | Cordial with | nd | nd | nd | 33.57 | 0.03345 | 70.0 | 83.6 | 89.9 | 0 | 99.1 | |
| 5200R | graphite | | | | | | | | | | | |
| BioFoam | Cordial | 5 | 20 mm | 33-38 | 28.75 | 0.03721 | 66.1 | nd | 51.2 | 0 | nd | |
| | | | | (15 min) | | | | | | | | |
| BioFoam | Vinex | 5 | 20 mm | 33-36 | 27.55 | 0.03706 | 59.4 | nd | 58.3 | 0 | nd | |
| | | | | (15 min) | | | | | | | | |
| BioFoam | Vinex | 10 | 30 mm | 50 | 36.14 | 0.03595 | 103.2 | nd | 167.1 | 51.4 | nd | |
| | | | | (15 min) | | | | | | | | |
| BioFoam | Vinex | 10 | 30 mm | 50 | 37.67 | nd | nd | nd | 185 | 81.3 | nd | |
| | | | | (15 min) | | | | | | | | |
| | | | | +80 | | | | | | | | |
| | | | | (30 min) | | | | | | | | |

nd = not done

1. A method for the production of foam moulded parts based on polymer foam granules, wherein the method comprises the following steps:
i) the provision of polymer foam granules,
ii) mixing the polymer foam granules with a glue composition,
iii) flowing a heat transfer medium through the mixture obtained in step ii) to obtain said foamed moulded part.

2. The method according to claim 1, wherein hot air is used as said heat transfer medium.

3. The method according to claim 1 wherein the polymer foam granules are selected from the group consisting of expanded polylactic acid, polylactic acid-starch mixture, polylactic acid-poly(butylene adipate-co-terephthalate) mixture, polylactic acid with polyhydroxyalkanoate compounds, expanded polystyrene, expanded polystyrene/poly(p-phenyleneoxide, expanded polypropylene, expanded polyethene, expanded polyethylene terephthalate, starch foam, or one or more combinations thereof.

4. The method according to claim 1 wherein the glue composition comprises one or more of the components based on polyvinyl alcohol, polyvinyl acetate en styrene.

5. The method according claim 1 wherein step ii) further comprises adding the mixture of glue composition and polymer foam granules to two pressure bodies and subsequently exerting pressure via the said pressure bodies.

6. The method according to claim 5 wherein the pressure bodies comprise two parallel arranged transport bands between which the mixture of glue composition and polymer foam granules is located.

7. The method according to claim 1 wherein the glue composition further comprises one or more additives, selected from the group consisting of colouring agents, materials to increase the heat insulation value and flame retarding agents, and antistatic agents.

8. The method according to claim 1 wherein already pre-foamed polymer granules are used in step i).

9. The method according to claim 1 wherein the amount of blowing agent present in the in step i) used polymer granules is lower than 0,1 weight % by mass, based on the weight of the polymer foam granules.

10. The method according to claim 1 wherein no impregnation with a blowing agent is conducted during or between one or more of steps i), ii) and iii).

11. A moulded part based on polymer foam granules and a glue composition obtained according to the method according to claim 1.

12. A growth substrate for plants and vegetables comprising the moulded part according to claim 11.

13. An insulation panel for interior wall insulation comprising the moulded part according to claim 11.

14. A moulded part based on polymer foam granules and a glue composition obtained according to the method according to claim 2.

15. A moulded part based on polymer foam granules and a glue composition obtained according to the method according to claim 3.

16. A moulded part based on polymer foam granules and a glue composition obtained according to the method according to claim 4.

17. A moulded part based on polymer foam granules and a glue composition obtained according to the method according to claim 5.

18. A moulded part based on polymer foam granules and a glue composition obtained according to the method according to claim 6.

19. A moulded part based on polymer foam granules and a glue composition obtained according to the method according to claim 7.

20. A moulded part based on polymer foam granules and a glue composition obtained according to the method according to claim 8.
